(19) United States
(12) Patent Application Publication
(10) Pub. No.: US 2025/0250434 A1
(43) Pub. Date: Aug. 7, 2025

(54) BIODEGRADABLE POLYMER MATERIAL

(71) Applicants: BIOAFFIN Handels GmbH, Weyer (AT); E.L.T. Holding GmbH, Friedberg (AT)

(72) Inventors: Friedrich ZITZ, Friedberg (AT); Klaus STEINECK, Weyer (AT); Karl RAMETSTEINER, Linz (AT)

(21) Appl. No.: 19/046,782

(22) Filed: Feb. 6, 2025

(30) Foreign Application Priority Data
Feb. 6, 2024 (EP) 24155908.7

(51) Int. Cl. C08L 67/03; C08K 3/013; C08L 3/02

(52) U.S. Cl. CPC C08L 67/03; C08K 3/013; C08L 3/02; C08K 2201/018; C08L 2201/06; C08L 2205/02; C08L 2205/035

(57) ABSTRACT

The present patent application relates to a biodegradable polymer material comprising a biodegradable polymer matrix, wherein the polymer matrix comprises at least one zeolite and at least one biodegradable and/or water-soluble filler.

### TECHNICAL FIELD

The present invention relates to the field of biodegradable polymer materials.

### BACKGROUND OF THE INVENTION

Two complementary trends are currently being observed to overcome the predicted environmental crisis.

It is well known that fossil fuel sources, such as oil and natural gas, are not inexhaustible, but will become scarce and/or dry up in the foreseeable future. As a result, there is a risk that essential products and processes, which are the basis of our culture and our prosperity, will no longer be (sufficiently) available. These include, in particular, polymer materials and the application products made from them. There is therefore a need for alternative sources of supply based on renewable raw materials to cover the carbon content in many polymers. The use of renewable raw materials also minimizes or prevents the CO₂ footprint, i.e. the emission of CO₂ from fossil sources.

In addition to the welcoming trend towards recycling, which is optimally used for thermoplastic polymers, there is a further demand for polymers that cannot be recycled for various reasons (lack of durability during recycling, lack of logistics during collection, extreme contamination, significant degradation during their useful life, etc.) to be made biodegradable than just used for energy (through incineration), as is currently the case in most cases. From an ecological point of view, there are significant advantages to compostability:
Applicability in all geographical areas
Neutralization of the CO₂ footprint when using renewable raw materials in the original production processes.
In agricultural practice (including fishing and forestry), however, there are applications in which the plastics should not actually remain on the ground, but in practice are demonstrably not (completely) recovered. Examples are fragments of mulch films, wrappings for hay or silage bales, sweep protection covers, etc. This is particularly often the case with small planting aids that are too small or too attached to the soil, such as plant fastening clips, straps, cords or pegs, plant rearing containers, fragile support elements, etc.
Special cases, such as urns, but also thin-walled polymer coffins or fabrics, which mandatory for certain burial rites, can therefore made from readily biodegradable polymers.
There are also applications of plastics in which they are deliberately introduced into the soil. This applies to fertilizers coated with plastic coatings, which enable a controlled release of nutrients, or coated seeds. Biodegradable plastics can sometimes be a solution here if they are suitable for the respective degradation conditions on site (temperature, humidity, etc.).

Biodegradable polymer materials are well known in the state of art. EP 2 353 862 A2 discloses biodegradable polymer compositions including organic or inorganic fillers.

KR 102355548 B1 describes a method of producing a biodegradable polymer composition which may include rice powder and an auxiliary agent like calcium carbonate.

KR 20200024976 A discloses a biodegradable resin composition for preparing environmentally friendly straws, which may further comprise an inorganic filler.

EP 1 265 957 B1 discloses a composition including starch, a plasticizer and an inorganic filler (e.g. calcium carbonate).

It is a task of the present invention to provide polymer materials or (useful) objects made of these polymer materials which can be biodegraded or composted rapidly and ideally in a time-controlled manner. This can be achieved by the implementation of pore structures in micro and/or nano range resulting in a forced degradation of the biodegradable polymer matrix.

### SUMMARY OF THE INVENTION

The present invention relates to a biodegradable polymer material comprising a biodegradable polymer matrix, wherein the polymer matrix comprises at least one zeolite and at least one biodegradable and/or water-soluble filler.

The basically biodegradable polymer matrix assumes the main load of the required mechanical properties, such as hardness, elasticity, stiffness, tensile strength, elongation and the like, over the predicted and required service life of the object (product) manufactured from it. These properties can generally be influenced by fillers, such as zeolite. At the same time, biodegradation, which may occur beforehand, should be accelerated after use.

Zeolite particles are especially suitable as fillers because they can increase the stiffness and strength of polymers, resulting in improved mechanical resilience. This is particularly important for applications that require high mechanical stresses. By adding zeolite as a filler, the heat distortion temperature of a polymer can be increased. This means that the polymer can retain its shape at higher temperatures. Zeolite can also help to improve the dimensional stability of polymers. This means that the polymer is less susceptible to shrinkage or deformation, especially with changes in temperature and humidity.

Additionally, zeolites provide a very large inherent surface area, which is, however, only slightly effective in the biodegradation process during use, as it is completely enclosed by the polymer matrix. However, if at least one other filler is introduced into the polymer matrix, which is preferably better, faster, more easily biodegradable and/or water-soluble than the polymer matrix, it is possible to generate larger pores (approx. factor 1000=nm/μm) from the outside. The size of these pores newly formed by degradation and/or by dissolving out the at least one additional excipient largely corresponds to the particle diameter or the fiber size of the at least one additional filler.

After use in a suitable new environment (e.g. soil, compost), the rapidly and greatly increased surface area now enables a significant increase in the degradation rate of the polymer matrix and thus of the polymer material due to the possibility of large-scale water exchange and the associated biological colonization, primarily by bacteria and fungi.

By providing biodegradable and/or water-soluble fillers in a polymer matrix, it is possible to increase the standardized degradation rates of polymers in the same amount of time (e.g. 60>80%). In addition, the degradation rate required by the standard can be achieved in a shorter time (e.g. 60 instead of 90 days). The polymer material according to the invention increases the compostability in practical applications (e.g. in households, farms).

Biodegradable polymers are mostly hydrophobic and therefore cannot absorb water. At best, such polymers can only be colonized by microorganisms from the (usually very smooth) surfaces. Penetration into the inner structures of the polymers is therefore more difficult and requires a disproportionate amount of time, even under otherwise optimal conditions. As already explained above, the presence of biodegradable and/or water-soluble fillers in the polymers or in the polymer material according to the invention makes it possible for microorganisms, among other things, to penetrate into the polymer material through the cavities formed. These microorganisms are able to degrade the polymer or the polymers of the polymer matrix.

It was found that the implementation of pore structures (e.g. in the micro and/or nano range) enables a forced and significantly accelerated degradation of the biodegradable polymer matrix. This is achieved by zeolites, which serve as water reservoirs and are also accessible to bacterial colonization. The same effect can also be achieved by other nanoporous fillers, such as minerals and silica, activated carbon and carbon black. In addition, mineral-based nanoporous fillers can, for example, have catalytic and ion exchange properties.

Another aspect of the present invention relates to an object comprising or consisting of a polymer material according to the present invention.

The polymer material according to the invention can be part of objects or the objects consist of the polymer material according to the invention. Another aspect of the present invention relates to a process for the preparation of a biodegradable polymer comprising the steps of blending at least one zeolite and at least one biodegradable and/or water-soluble filler with a biodegradable polymer matrix.

The process according to the invention makes it possible to produce a polymer material which is biodegradable.

### DESCRIPTION OF THE EMBODIMENTS

“Biodegradable polymer material” includes a biodegradable polymer matrix (i.e., a biodegradable polymer), wherein “biodegradable” includes processes by which microorganisms (environmental or added) convert the polymer matrix or polymer into compounds found in nature, such as water, carbon dioxide and/or methane. It is particularly preferred that the biodegradation is controlled. “Controlled” degradation means that the degradation of the polymer material is induced and/or supported by environmental conditions favouring the catalytic activity of microorganisms and/or enzymes capable of breaking down the polymer matrix.

There are internationally recognized evaluation criteria for comparative verification of biodegradability and compostability, such as EN 13 432:2000, EN 17 033, DIN EN ISO: 20.200, DIN EN L4995 2AO7, ISO 17088.2008, ASTM G22, ASTM D 5400 and OECD 301B, 301D, 301F.

A “polymer matrix” as used herein comprises at least one biodegradable polymer or may consist of at least one biodegradable polymer. Depending on the requirements for the polymer material according to the invention, the polymer matrix comprises at least one, two, three, four, five or ten different types of biodegradable polymers.

“Zeolites” in polymers are nanostructured, porous materials, preferably in the form of particles, and can be used in polymers to modify their properties. Zeolites can provide the polymer materials with exceptional mechanical, thermal, electrical and optical properties.

The nanoporosity of zeolites is achieved by a high number of tiny pores in their structure, which have dimensions in the nanometer range. These pores provide a larger surface area that allows the zeolite to interact and bond with the polymer. This leads to an improved bond between the zeolite and the polymer, resulting in altered mechanical properties of the polymer material in terms of strength, stiffness and hardness.

In addition, zeolites also have greater reactivity due to their large surface area, which enables them to undergo chemical reactions with the polymer. In addition, the nanoporous structure can also serve as a reservoir for additives that are added to the polymer to provide specific properties.

Zeolites can also change the thermal properties of polymers. Due to their high surface area and pore structure, they can act as heat insulators, which is particularly advantageous in composting.

According to a preferred embodiment of the present invention, the at least one zeolite is present as a particle and has a D90 value of 2 to 40 μm, preferably from 2 to 25 μm, even more preferably from 2 to 20 μm, even more preferably from 5 to 20 μm.

The D90 value for particles is a term used in particle analysis and indicates the diameter of the particle where 90% of the particles are smaller than the specified diameter range. This value is useful to characterize the size distribution of particles in a sample.

The D90 value for particles is preferably determined using certain standardized methods such as laser diffraction or sieve analysis.

DIN EN ISO 13320-1:2009, for example, specifies the basic principles of laser diffraction methods for measuring particle size. Another method for determining the D90 value is sieve analysis (see DIN EN ISO 3310-1:2000).

According to a particularly preferred embodiment of the present invention, the at least one zeolite has a pore size of 0.2 to 20 nm, preferably from 0.3 to 10 nm, even more preferably from 0.4 to 5 nm.

The pore size of zeolite particles refers to the dimensions of the cavities or recesses within these particles. The pore size can be measured and determined in various ways.

DIN-EN ISO 9277:2010 is a standard that describes the determination of the specific surface area of porous materials by nitrogen adsorption. This method makes it possible to determine the pore size and the total pore volume of particles. It is based on the principle of adsorption of nitrogen gas on the surface of porous materials, whereby the adsorption occurs in relation to the size of the cavities.

Another approach to determine the pore size is the use of pore size distributions, which represent the proportion of pores in different size ranges. DIN 66133-1:1976-06 describes the determination of the pore size distribution of powders using the carboxymethylcellulose BT method. This method is based on the use of a special dye that selectively adsorbs to the surface of the particles. The pore size distribution can be determined by digital image analysis.

Another example is ISO 13317-1:2014, which describes the determination of the particle size distribution of powders by laser diffraction. Although this is primarily a method for determining particle size, it can also be used to obtain information about pore size. A change in pore size leads to a change in light scattering, which can be measured by laser diffraction.

According to a preferred embodiment of the present invention, the at least one zeolite can be replaced by or supplemented with any nanoporous filler such as a mineral, precipitated silica, activated carbon or an metal-organic framework compound, wherein mineral particles are particularly preferably used as nanoporous fillers.

Metal-organic framework compounds, also known as metal-organic frameworks (MOFs) or coordination polymers, are compounds consisting of transition metal ions or metal clusters linked together by organic ligands. These framework compounds are characterized by their high surface area and pore structure. MOFs can be used as fillers in polymers. MOFs, which have a zeolite-like structure, can serve as fillers for polymers. They offer a large surface area and pore structure that can be used to absorb gases and other molecules. Pillared MOFs are characterized by their pillar structure, which keeps the pores of the material open and improves the adsorption capacity. Hierarchical MOFs can improve the mechanical properties and adsorption capacity of polymers.

MOFs containing Fe(II) and/or Fe(III) are particularly preferred. Examples are Fe-BDC (Fe(II)-1,4-benzenedicarboxylate), MIL-100 (Fe(III)-trimesate), Fe-MOF-74 (Fe(II)), FeTDP (Fe(III)-tetra(4-carboxyphenyl)porphyrinate), FeTCPP (Fe(III)-tetra(4-carboxyphenyl)porphyrin), Fe-bpy-MOF, MIL-88B (Fe(III)-bipyridyl), Fe-tpy-MOF (Fe(II)-terpyridine) and MIL-101 (Fe(III)-terpyridine).

According to a further preferred embodiment of the present invention, the zeolite comprises or consists of clinoptilolite.

According to a preferred embodiment of the present invention the polymer material comprises 2 to 30 wt %, preferably 2 to 25 wt %, more preferably 2 to 20 wt %, even more preferably 2 to 15 wt %, even more preferably 2 to 10 wt %, even more preferably 3 to 8 wt %, of the at least one zeolite.

According to a particularly preferred embodiment of the present invention, the at least one biodegradable and/or water-soluble filler is present as particles and/or as fibers.

In a particular embodiment, it is not (spherical) particles that are used, but finely divided fibrous materials, for example as ground material from plant parts. This does not generate spherical pores, but fine open channels within the polymer material in the course of degradation, which enable particularly advantageous reactions. In addition, fibrous fillers can act as reinforcing agents in objects of daily use (e.g. in tapes, fastenings, tie rods in agriculture, etc.).

According to a preferred embodiment of the present invention, the at least one biodegradable and/or water-soluble filler is present as a particle and has a D90 value of from 5 to 100 μm, preferably from 10 to 100 μm, even more preferably from 10 to 50 μm, even more preferably from 5 to 30 μm.

According to a preferred embodiment of the present invention, the at least one biodegradable and/or water-soluble filler is selected from the group of carbohydrates, preferably a monosaccharide, a disaccharide, a polysaccharide or a derivative thereof.

Particularly preferred monosaccharides are glucose, fructose and galactose. Particularly preferred disaccharides are sucrose, lactose and maltose. Particularly preferred polysaccharides are cellulose, starch, chitin and pectin.

Carbohydrates are particularly preferred because they are relatively temperature-stable and can therefore be easily processed (e.g. extruded) with the polymer matrix. In addition, mono-and disaccharides and polysaccharides are readily biodegradable. In contrast to polysaccharides, mono- and disaccharides have good water solubility due to their molecular size. These carbohydrates are therefore particularly suitable as fillers in the polymer material according to the invention for creating cavities in the polymer before or during biodegradation.

Particularly preferred are derivatives of cellulose, starch, chitin and/or pectin. Preferred cellulose derivatives are cellulose ethers such as carboxymethyl cellulose (CMC) and hydroxypropyl cellulose (HPC). Preferred starch derivatives are starch esters and starch ethers. A preferred chitin derivative is chitosan. Preferred pectin derivatives include pectin esters.

According to a preferred embodiment of the present invention, the at least one water-soluble filler which is a phosphate or a sulfate.

The at least one water-soluble filler may be a salt, preferably a reactive salt, which may react with hydroxyl groups of other compounds, such as carbohydrates. Phosphates and/or sulphates are therefore particularly preferred. Phosphates are particularly preferred because they are also effective as fertilizers.

According to a preferred embodiment of the present invention, the phosphate is a salt, preferably a sodium phosphate, a potassium phosphate or an ammonium phosphate.

Preferred sulphates are sodium sulphate, potassium sulphate or magnesium sulphate.

The degradation rate of the polymer material or polymer matrix can be controlled by the choice of degradable or water-soluble fillers. The faster cavities are formed within the polymer material by degradation or dissolution of the at least one biodegradable and/or water-soluble filler, the faster microorganisms or enzymes, for example, can reach the vicinity of the polymer to be degraded. The desired degradation rate can therefore be influenced by the selection of the at least one biodegradable and/or water-soluble filler material. It is therefore particularly preferable to combine several biodegradable and/or water-soluble fillers.

According to a preferred embodiment of the present invention, the polymer material comprises 1 to 20 wt %, preferably 1 to 15 wt, even more preferably 1 to 10 wt %, even more preferably 1 to 8 wt %, even more preferably 2 to 8 wt %, of the at least one biodegradable and/or water-soluble filler

According to a preferred embodiment of the present invention, the biodegradable polymer matrix is selected from the group consisting of thermoplastic starch, polylactic acid, polybutyl succinate, polyhydroxyalkanoates, poly(butylene adipate-co-terephthalate), polycaprolactones, polyalkyene glycols and copolymers thereof.

Biodegradable polymers (i.e. the biodegradable polymer matrix) are well known to those skilled in the art. Biodegradable polymers are materials that can be degraded by microorganisms or enzymes in the environment. In contrast to conventional polymers, which degrade very slowly or not at all, biodegradable polymers offer a promising solution to the problem of plastic pollution.

There are different types of biodegradable polymers that can be produced from natural raw materials or synthetically. A well-known example of a natural biodegradable polymer is starch. Starch is derived from plants and can be soluble in water or in the form of granules. It is often used for packaging applications as it is biodegradable and inexpensive

Starch can be obtained from plants and processed into thermoplastic starch as described in WO 2021/005190, for example. Thermoplastic starch is a starch product obtained by partial or complete gelatinization of starch. This process results in the starch molecules being cross-linked or partially dissolved. Cationic modification increases the thermoplastic properties of the starch, which leads to better film formation. The use of oxidizing agents chemically modifies the starch in order to increase its water absorption capacity and improve its gel-forming properties. In addition, chemical ester groups can be bound to the starch molecules in thermoplastic starch in order to influence its water solubility. The starch can also be provided with reactive groups to improve its cross-linking ability and enhance its thermoplastic properties.

Another example of a biodegradable polymer is polylactic acid (polylactide, PLA). Polylactic acid is produced from plant-based raw materials such as corn starch or sugar cane. Polylactic acid is biodegradable and can be degraded under the conditions of an industrial, domestic and/or agricultural composting facility.

Polyhydroxyalkanoates (PHA) are synthesized by bacteria and are therefore of biological origin, but can also be produced synthetically as oligomeric polylactones, whereby, depending on the chain length, water-soluble PHA's are also available.

Other examples of biodegradable polymers are polybutylene succinate (PBS) and polybutylene adipate terephthalate (PBAT).

According to a preferred embodiment of the present invention, the polymer material comprises 50 to 98 wt %, preferably 60 to 95 wt %, even more preferably 70 to 90 wt %, even more preferably 75 to 90 wt %, of the polymer matrix.

According to a preferred embodiment of the present invention, the polymer material comprises at least one phyllosilicate, preferably 0.5 to 10 wt %, more preferably 1 to 10 wt %, still more preferably 1 to 5 wt %, still more preferably 2 to 4 wt, of the at least one phyllosilicate.

It has been shown that a certain proportion of phyllosilicates (such as talc, bentonite, laponite, montmorillonite, mica) can be particularly advantageous when using the polymer material according to the invention in films, but also in thick-walled objects/components. In the production process, the platelets of the layered silicates orient themselves in the longitudinal direction and thus have a positive effect on the strength of the polymer material. The temperature resistance of the polymer material during processing can also be positively influenced by phyllosilicates. During biodegradation, it was found that the majority of phyllosilicates, in particular bentonite, laponite and montmorillonite, can contribute to swelling with water and thus to cracking of the polymer structures. This can also contribute to accelerated biodegradation of the polymer matrix or polymer material.

According to a preferred embodiment of the present invention, the at least one phyllosilicate is selected from the group consisting of montmorillonite, laponite, talc, bentonite and mica.

According to a preferred embodiment of the present invention, the polymer material comprises at least one biodegradable, preferably functional, pigment.

Optionally, the polymer material includes color pigments, which can or should also be biodegradable if possible. Ideally, pigments are used that neither negatively affect the polymer material nor the biodegradation process. In addition, pigments can also be used that have no negative impact on the environment and may even be useful as soil or plant strengthening agents.

Examples of possible (biodegradable) pigments are chlorophyll, curcumin, betanin, anthocyanin, carotenoid, lycopene, anthocyanidin, phycocyanin, chlorophylloid, chlorophyllin, betalain, indican, bacteriorhodopsin, C-phycocyanin, C-phycoerythrin and zeaxanthin.

According to a preferred embodiment of the present invention, the polymer material comprises 0.05 to 5 wt %, preferably 0.1 to 5 wt %, more preferably 0.1 to 3 wt %, still more preferably 0.1 to 2 wt %, of the at least one pigment.

According to a preferred embodiment of the present invention, the at least one zeolite and/or the at least one biodegradable and/or water-soluble filler is at least partially accessible on the surface of the polymer material.

In order to promote the degradation of the polymer material according to the invention, in particular the polymer matrix or the polymer, the at least one zeolite and/or the at least one biodegradable and/or water-soluble filler material, but in particular the at least one biodegradable and/or water-soluble filler material, should be accessible so that it is exposed to corresponding environmental influences. The (further) accessibility of the at least one biodegradable and/or water-soluble filler material can be achieved using different methods.

For example, mechanical measures (e.g. roughening) on the surface of the polymer material can be used to make the at least one biodegradable and/or water-soluble filler material in the polymer material at least partially accessible. Alternatively, the polymer material can be exposed to certain solvents. The polymer material can be exposed to a high-energy plasma atmosphere, which makes the at least one biodegradable and/or water-soluble filler material accessible. The use of ion beams is also possible.

Another aspect of the present invention relates to an object comprising a polymer material according to the present invention as set forth above.

The polymer material according to the invention can be formed into any conceivable shape and is thus suitable for producing objects which can also be produced from conventional polymer materials. Ideally, in particular such objects comprise the polymer material according to the invention which tend to or unintentionally and practically unavoidably end up in the environment, in particular in the soil or in water (e.g. disposable items such as container closures).

According to a preferred embodiment of the present invention, the object is a packaging object, a food and/or non-food container, an agricultural object and/or a horticultural object.

Preferred objects are containers for food and non-food products, lawn or garden equipment, horticultural products, agricultural products, growing pots, urns, cable ties, quick ties, weed fleece, harvest nets, bark protection, grub protection, browsing protection, tree trunk protection and the like. Above all in horticulture and agriculture, objects with the polymer material according to the invention can be used very well. For example, plant pots, growing pots and root protection nets made of the polymer material according to the invention can be inserted directly into the soil, where they degrade over time. Fastening materials with which the branches of trees, vines and shrubs are fastened can also be made from or comprise the polymer material according to the invention.

In a preferred embodiment, the biodegradable polymer material according to the invention can also be used for the manufacture of fireworks or parts thereof. This is because many fireworks or parts thereof consist of plastic compounds such as polyethylene or polypropylene, which are not biodegradable. The outer container of fireworks is usually made of plastic. The end cap of a firework, which often serves as a seal on the tube, can also be made of plastic. Since spent fireworks are practically never collected, these plastic parts in particular can remain in the environment for a very long time and thus contribute to the waste problem. By using the polymer material according to the invention, the environmental impact of fireworks can be significantly reduced.

The object according to the invention can also be a composite material which, in addition to at least one layer or film of the biodegradable polymer material according to the invention, comprises other layers on likewise biodegradable polymers, such as cellulose, starch and derivatives thereof. A further aspect of the present invention relates to a process for preparing a biodegradable polymer material comprising the steps of blending at least one zeolite and at least one biodegradable and/or water-soluble filler as defined above with a biodegradable polymer matrix as also defined above.

Processes for the production of polymer materials comprising polymers or a polymer matrix and fillers are well known and include mixing and kneading and optional granulation processes for obtaining precursors for injection molding, extrusion, rolling, calendering, film blowing and nonwoven processes.

The present invention is explained in more detail with reference to the following examples, but is not limited to these.

### EXAMPLES

The respective compositions of the following examples were granulated in advance using a compounding plant with vacuum degassing zones along the compounding screw zones. The resulting granules were pre-dried for 6 h at 40 to 50° C. before further processing (injection molding, extrusion, etc.) and processed immediately afterwards.

A conical plant cultivation cup with the following dimensions was produced using injection molding:
d/U: 45 mm, d/O: 60 mm
Height: 57 mm
Wall thickness: 1 mm
Weight (depending on the composition) 10.4-13.5 g

An extrusion process was used to produce a trapezoidal cross-section plant support rod with the following dimensions:
a=6 mm
c=4 mm
h=4.5 mm, corresponding to a volume of 22.5 cm³/lfm bar

Thus (depending on the composition) the weight per meter was 30-36 g.

The compostability was carried out in a first phase of the comparative assessment based on DIN EN ISO 20 200, thus determining the degree of decomposition under standardized conditions after 30, 60 and 90 days.

These investigations serve to illustrate the concept according to the invention for improving the compostability of biodegradable plastics.

### Formulations

1) Polymer matrix (A1, 11-13) Characterization and volume fraction
2) Nanoporous filler (A 1-5) Characterization and amount
3) Additional filler (A 1, 6-10) Characterization and amount

In the comparative examples 1 to 5, commercially available finished granules labeled “biodegradable/compostable” were processed into the products described above (cup and binding stick) without the addition of the additives according to the invention.

### Comparative example 1

| | | |
|---|---|---|
| Thermoplastic starch (TPS) AGENACOMP F 40 | 100 | wt % |
| Injection molding: | 130-140° | C. |

### Comparative example 2

| | | |
|---|---|---|
| Polybutylene sebacate (PBSeb) BIOPOL 707 | 100 | wt % |
| Injection molding: | 45-65° | C. |

### Comparative example 3

| | | |
|---|---|---|
| Polybutylene adipate terephthalate | 100 | wt % |
| (PBAT) BOIPOL 1160 | | |
| Injection molding: | 110-135° | C. |

### Comparative example 4

| | | |
|---|---|---|
| Polybutylene succinate (PBS) | 100 | wt % |
| Extrusion: | 105-145° | C. |

### Comparative example 5

| | | |
|---|---|---|
| Polylactic acid (PLA) Nature Plast PLE 005 - A | 100 | wt % |
| Injection molding: | 160-180° | C. |

TABLE 1
Testing the degree of decomposition of the comparative samples
(weight loss of the test specimens in %, after 2 mm sieve)

| Comparative | | | |
|---|---|---|---|
| example | 30 days | 60 days | 90 days |
| 1 | 28% | 52% | 88% |
| 2 | 19% | 37% | 61% |
| 3 | 17% | 30% | 50% |
| 4 | 20% | 36% | 64% |
| 5 | 15% | 29% | 48% |

In Examples 1 to 5, compositions according to the invention were processed into the products described above (cup and binding rod).

### Example 1

| | | |
|---|---|---|
| Matrix: AGENACOMP F 40 (TPS) | 81 | wt % |
| Nanop. Filler: Zeolite BIOAFFIN KAD 10 - 4 | 15 | wt % |
| Other fillers: TENCEL - Cellulose 50 μm | 2.5 | wt |
| KH₂PO₄ | 1.5 | wt % |

(Note: Zeolite KAD 10 - 4 is a natural clinoptilolite with
approx. 9% phyllosilicate content (mica, clay, clazite))

| | | |
|---|---|---|
| Injection molding: | 155-175° | C. |

### Example 2

| | | |
|---|---|---|
| Matrix: Biopol 707 (PBSeb) | 8 | wt % |
| Biopol 1160 (PBAT) | 65 | wt % |
| AGENDCOMP F 40 (TPS) | 7 | wt % |
| Nanoporous filler: BIOAFFIN KAD 10 - 4 | 15 | wt % |
| Other fillers: KH₂PO₄ | 1.5 | wt % |
| Dextrose | 3.5 | wt % |
| Injection molding: | 160-195° | C. |

### Example 3

| | | |
|---|---|---|
| Matrix: Ecoflex SL05 (PBAT) | 72 | wt % |
| Nanoporous filler: BIOAFFIN KAD 10 - 4 | 12 | wt % |
| Other fillers: TENCEL Cellulose 50 μm | 12 | wt % |
| Phyllosilicate: talc 10 μm | 4 | wt % |
| Injection molding: | 165-195° | C. |

### Example 4

| Matrix: ECOVIO M 2351 (PLA/PBAT blend) | 76% | |
|---|---|---|
| Nanoporous filler: BIOAFFIN KAD 10 - 4 | 18% | |
| Additional filler: cellulose fiber short cut | 1-1.5 | mm |
| | 6 | wt % |
| Extrusion: | 140-210° | C. |

### Example 5

| | | |
|---|---|---|
| Matrix: Naturplast PLE 005 - A (PLA) | 83 | wt % |
| Nanoporous fillers: silica gel 10 μm | 6.4 | wt % |
| Active carbon black 1 μm | 1.2 | wt % |
| Zeolite/clinoptilolite 5 μm | 4.4 | wt % |
| Additional filler: PEG 4000 | 5.0 | wt % |
| Extrusion: | 135-195° | C. |

TABLE 2
Testing the degree of decomposition of the comparative samples
(weight loss of the test specimens in %, after 2 mm sieve)

| Example | 30 days | 60 days | 90 days |
|---|---|---|---|
| 1 | 39% | 74% | 96% |
| 2 | 37% | 66% | 91% |
| 3 | 26% | 59% | 90% |
| 4 | 24% | 48% | 86% |
| 5 | 22% | 54% | 85% |

1. Biodegradable polymer material comprising a biodegradable polymer matrix, wherein the polymer matrix comprises at least one zeolite and at least one biodegradable and/or water-soluble filler.

2. Polymer material according to claim 1, wherein the at least one zeolite is present as a particle and has a D90 value of 2 to 40 μm.

3. Polymer material according to claim 1, wherein the at least one zeolite has a pore size of 0.2 to 20 nm.

4. Polymer material according to claim 1, wherein the at least one zeolite comprises clinoptilolite.

5. Polymer material according to claim 1, wherein the polymer material comprises 2 to 30 wt % of the at least one zeolite.

6. Polymer material according to claim 1, wherein the at least one biodegradable and/or water-soluble filler is present as particles and/or as fibers.

7. Polymer material according to claim 1, wherein the at least one biodegradable and/or water-soluble filler is present as a particle and has a D90 value of 5 to 100 μm.

8. Polymer material according to claim 1, wherein the at least one biodegradable and/or water-soluble filler is selected from the group of carbohydrates or is a derivative thereof.

9. Polymer material according to claim 1, wherein the at least one water-soluble filler is a phosphate or a sulphate.

10. Polymer material according to claim 1, wherein the polymer material comprises 1 to 20 wt % of the at least one biodegradable and/or water-soluble filler.

11. Polymer material according to claim 1, wherein the biodegradable polymer matrix is at least one polymer selected from the group consisting of thermoplastic starch, polylactic acid, polybutyl succinate, polyhydroxyalkanoates, poly(butylene adipate-co-terephthalate), polycaprolactones, polyalkyene glycols and copolymers thereof.

12. Polymer material according to claim 1, wherein the polymer material comprises 50 to 98 wt % of the polymer matrix.

13. Polymer material according to claim 1, wherein the polymer material comprises at least one phyllosilicate.

14. Polymer material according to claim 1, wherein the polymer material comprises 0.5 to 10 wt % of at least one phyllosilicate.

15. Polymer material according to claim 1, wherein the at least one zeolite and/or the at least one biodegradable and/or water-soluble filler is at least partially accessible on the surface of the polymer material.

16. An object comprising a polymer material according to claim 1.

17. Process for the preparation of a biodegradable polymer material comprising the steps of blending at least one zeolite and at least one biodegradable and/or water-soluble filler with a biodegradable polymer matrix.
